(19) United States
(12) Patent Application Publication
(10) Pub. No.: US 2026/0223111 A1
(43) Pub. Date: Jul. 30, 2026

(54) MULTIPLEXING AND PRIORITY INDICATION FOR TWO CODEWORD TRANSMISSIONS

(71) Applicant: InterDigital Patent Holdings, Inc., Wilmington, DE (US)

(72) Inventors: Afshin Haghighat, Ile-Bizard (CA); Jonghyun Park, Syosset, NY (US); Moon IL Lee, Melville, NY (US); Mohammad Irfan, Chateauguay (CA); Loic Canonne-Velasquez, Dorval (CA)

(73) Assignee: InterDigital Patent Holdings, Inc., Wilmington, DE (US)

(21) Appl. No.: 19/150,241

(22) PCT Filed: Feb. 14, 2024
(86) PCT No.: PCT/US2024/015697

§ 371 Date: Jul. 23, 2025

Related U.S. Application Data
(60) Provisional application No. 63/445,569, filed on Feb. 14, 2023.
(60) Provisional application No. 63/617,903, filed on Jan. 5, 2024.

(51) Int. Cl. H04W 72/1268

(52) U.S. Cl. CPC H04W 72/1268

(57) ABSTRACT

A WTRU may be configured to transmit UL-SCH data and/or UCI using one or more CWs (e.g., a first CW (CW1) and a second CW (CW2)) based on a received UL-SCH indicator in an uplink (UL) grant. For example, the WTRU may receive an UL grant scheduling a PUSCH transmission with 2 CWs and/or an indication. The indication may be, for example, a UL-SCH indicator in the UL grant DCI. The WTRU may determine the value of the UL-SCH indicator (e.g., the value of the field in the UL grant DCI). In examples, the WTRU may transmit UL-SCH data and/or UCI using one or more of CW1 and CW2. The use of each CW for either UL-SCH data or UCI may be determined based on any of: the indication; a property and/or parameter of at least one of the CWs; and/or a criticality, importance, and/or priority of the UCI.

### CROSS-REFERENCE TO RELATED APPLICATIONS

This application claims the benefit of U.S. Provisional Patent Application No. 63/445,569 filed on Feb. 14, 2023, and U.S. Provisional Patent Application No. 63/617,903 filed on Jan. 5, 2024, the entire contents of which are incorporated herein by reference.

### BACKGROUND

An 8TX WTRU may support up to 8 layers for uplink transmission. For uplink transmission up to rank 4, a single CW (CW) may be supported. For transmissions with rank greater than 4, more than 1 CW may be used. An 8TX WTRU may transmit using more than one CW for uplink. A wireless transmit/receive unit (WTRU) may transmit up to 4 layers using a single CW transmission. For dynamic indication of transmission parameters and controls, there may be enhancements such as UL-SCH, beta_Offset, priority Indication, and the like. In examples, the number of indications may be increased proportionally to the number of CWs. However, increasing the number of indications proportionally may result in a usage increase for the downlink control channel.

### SUMMARY

A wireless transmit receive unit (WTRU) may be configured to receive an uplink (UL) grant that schedules a Physical Uplink Shared Channel (PUSCH) transmission using a first CW (CW) and a second CW. The UL grant may comprise an uplink shared channel (UL-SCH) indicator. The WTRU may be configured to determine a value of the UL-SCH indicator. The WTRU may be configured to determine to send UL-SCH data using the first CW and the second CW based on the UL-SCH indicator having a first value. If the UL-SCH indicator has a second value, the WTRU may determine to send UL-SCH data using the first CW. The WTRU may be configured to determine whether to send UL-SCH data or uplink control information (UCI) using the second CW based on the UL-SCH indication having the second value and a parameter. The WTRU may be configured to transmit UL-SCH data or UCI using the first and second CWs based on the determinations.

The parameter may be associated with the second CW. The parameter may comprise a configuration indicated in downlink control information (DCI), a modulation and coding scheme (MCS), an antenna group, a New Data Indicator (NDI), a hybrid automatic repeat request (HARQ) process identification, a transmission/reception port (TRP), or a sounding reference signal (SRS) resource indicator (SRI). The NDI may be either toggled or not toggled. The TRP may be either primary or secondary. The SRS may indicate whether the CW is associated with a first or second SRI. The parameter may comprise a priority of the UCI.

The priority may be associated with HARQ feedback or time critical CSI. The priority may indicate to transmit on the first CW or second CW.

The parameter may comprise a UCI size threshold. The WTRU may be configured send UCI using the second CW if UCI at the WTRU is greater than the UCI size threshold. The WTRU may be configured to send UL-SCH data using the second CW if the UCI at the WTRU is less than the UCI size threshold. The UL-SCH indicator may comprise a field in an UL grant DCI.

A WTRU comprising a processor may be configured to receive a UL grant that schedules a PUSCH transmission using a first CW (CW) and a second CW. The UL grant may comprise an UL shared channel (UL-SCH) indicator. The WTRU may be configured to determine a value of the UL-SCH indicator. The WTRU may be configured to determine whether to send UL-SCH data or uplink control information (UCI) using the first CW and the second CW based on the value. If the WTRU determines the UL-SCH indicator has a first value, the processor may be configured to determine to send UL-SCH data using the first CW and second CW. If the WTRU determines the UL-SCH indicator has a second value, the processor may be configured to determine to send uplink control information (UCI) using the first CW and second CW. The WTRU may be configured to transmit UL-SCH data or UCI using the first and second CWs based on the determinations. The UL-SCH indicator may comprise a field in UL grant DCI.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a table of an example mapping of four beta_offset indicator values to offset indexes.

FIGS. 3A-3B is an example flowchart illustrating a procedure for priority indication based on configured DCI field length.

### DETAILED DESCRIPTION

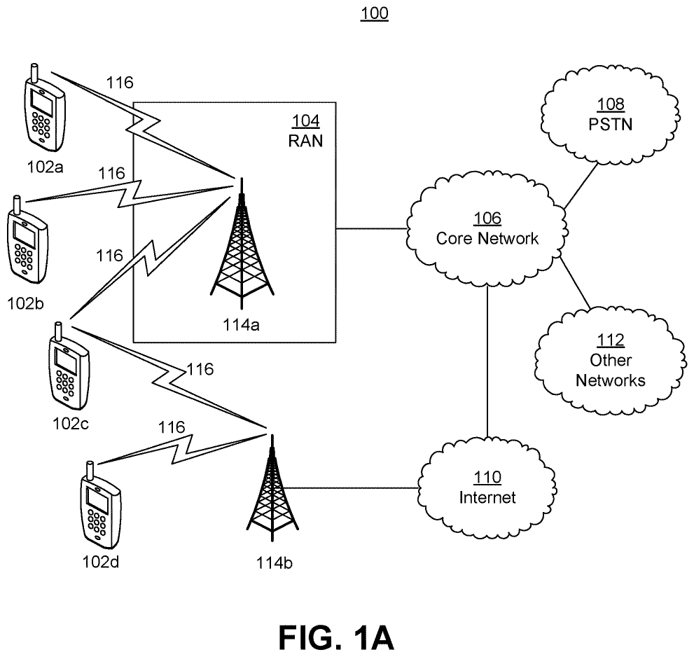

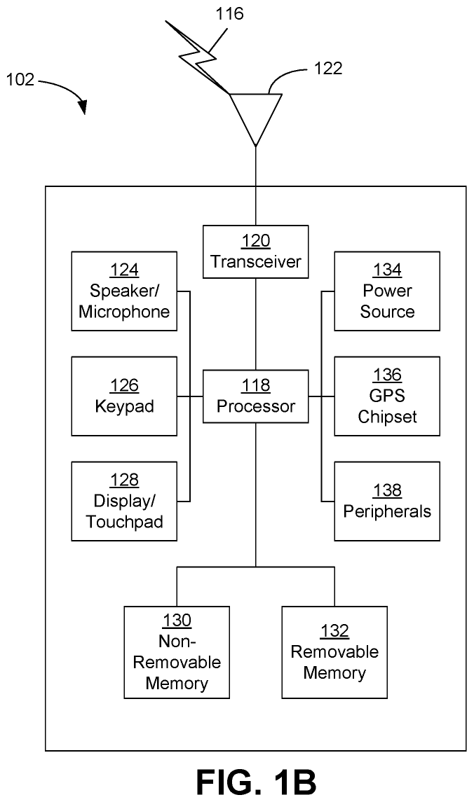

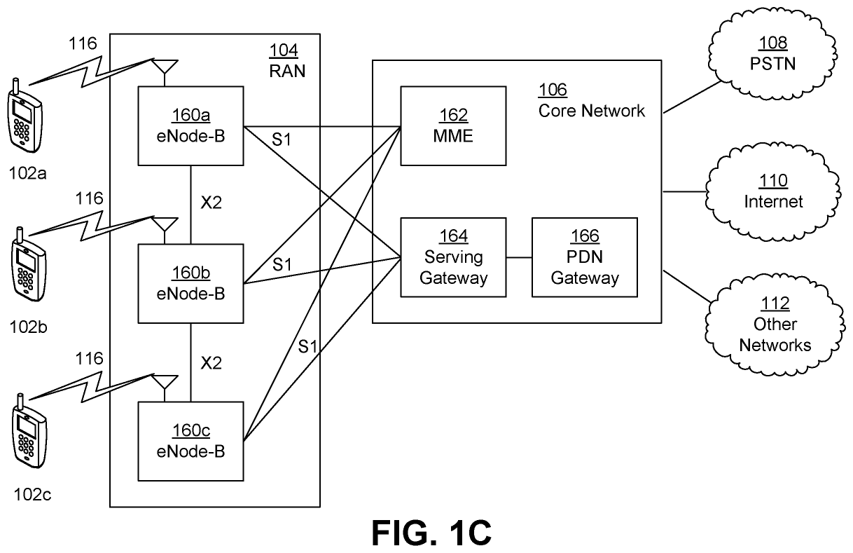

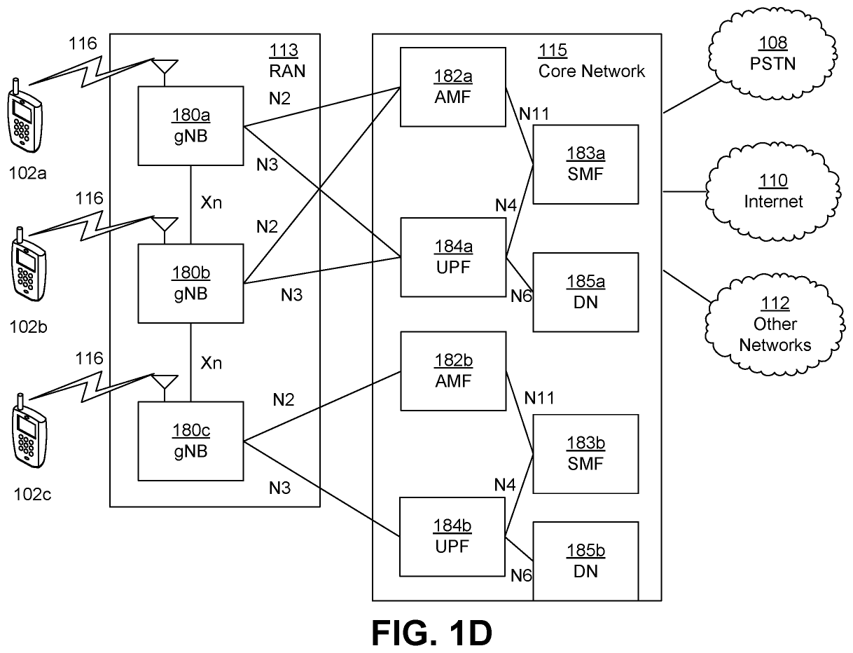

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

There may be coverage, reliability, and/or throughput enhancements for uplink transmission. For example, an eight-antenna (8TX) WTRUs may support eight layers for UL transmission. For uplink transmission up to rank four, a single codeword (CW) may be supported. However, for transmissions with rank greater than four, more than one CW may be used. The embodiments discussed herein may enable transmission of more than one CW for uplink with the focus on support of two CW transmission by an 8TX WTRU. It should also be understood that the embodiments discussed herein may be equally applicable to other cases of number of CWs and TX antenna size.

In examples, a WTRU may transmit four layers using a single CW transmission. To support more than one CW transmission in uplink, there may be a dynamic indication of transmission parameters and controls, for example, UL-SCH, beta_Offset, Priority Indication, etc. For instance, one approach may be to increase the number of such indications proportionally to the number of CWs. However, such solutions may result in an significant increase in the downlink control channel. As such, the embodiments discussed herein support dynamic indication of transmission parameters and controls for an uplink transmission with more than one CW.

There may be latency and/or coverage enhancements for multiplexing and/or priority indication for transmission of two CWs in UL. In examples, a wireless transmit/receive unit (WTRU) may be configured for enhanced dynamic indication of uplink shared channel (UL-SCH), beta offset, and/or priority indication. The WTRU may be configured to provide a UL-SCH indication for a two CW operation. The WTRU may provide (e.g., be configured for) UCI multiplexing for two CW transmission. In examples, the WTRU may be configured to provide a priority indication for a two CW transmission.

There may be a UL-SCH indication for two CW operation. A WTRU may be configured to transmit UL-SCH data and/or UCI using one or more CWs (e.g., a first CW (CW1) and a second CW (CW2) based on a received UL-SCH indicator. In examples, the WTRU may receive an UL grant scheduling a PUSCH transmission with 2 CWs and/or an indication. The indication may be, for example, but not limited to, an UL-SCH indicator that may be a field (e.g., a 1-bit field) in the UL grant DCI, and/or may have a value. The WTRU may determine the value of the UL-SCH indicator (e.g., the value of the field in the UL grant DCI). In examples, the WTRU may transmit UL-SCH data and/or UCI using one or more of CW1 and CW2. The use of each CW for either UL-SCH data or UCI may be determined based on any of: the indication; a property and/or parameter of at least one of the CWs; and/or a criticality, importance, and/or priority of the UCI. The parameter and/or property of at least one of the CW(s) may, for example, be based on configuration and/or indication in the DCI. In examples, the property and/or parameter may include one or more of: a modulation and coding scheme (MCS), an antenna group, a new data indicator (NDI), a HARQ process ID, a transmission/reception port (TRP), and/or a sounding reference signal (SRS) resource indicator (SRI). The NDI may be toggled or not toggled. The TRP may be primary or secondary. In examples, the SRS may indicate whether the CW is associated with a first or second SRI. The criticality, importance, and/or priority of the UCI may be based on, for example, HARQ feedback and/or time critical channel state information (CSI) indicated to be transmitted on a CW (e.g., a first CW, CW1, or a second CW, CW2). In examples, the criticality, importance, and/or priority may be based on a respective property or parameter of a CW. For example, if the UCI includes a CSI associated with a high (e.g., first) priority and a CSI associated with a low priority (e.g., a second priority, lower than the first priority), the WTRU may be configured to map the high or first priority CSI to the CW with the higher MCS and to map the low or second priority CSI to the CW with the lower MCS.

UCI multiplexing for a two CW transmission may be described herein. A WTRU may be configured to determine CW and/or resource usage for UCI multiplexing. The WTRU may receive a configuration of a threshold. For example, the WTRU may be configured to receive a configuration of a threshold to determine UCI splitting. In examples, the WTRU may be configured to receive a UL grant scheduling a PUSCH transmission with 2 CWs (e.g., a first CW, CW1, and a second CW, CW2). In examples, the WTRU may be configured to determine whether to transmit UCI using one or more CW(s) based on the size of the UCI. For example, if the UCI size is greater than a threshold, the WTRU may be configured to split the UCI in two parts, and transmit one part using CW1 and the other part using CW2. If the UCI size is less than the threshold, the WTRU may transmit the UCI using one CW (e.g., CW1 or CW2). One CW may be used for transmitting the UCI, for example, based on the size of the UCI. For example, the WTRU may transmit the UCI using the CW with the higher or lower MCS based on the priority of the UCI. In examples, the MCS of the CWs may be indicated by a scheduling grant (e.g., the scheduling DCI). The WTRU may determine one or more CW(s) based on the configuration, and transmit the UCI using the determined one or more CWs. For example, the WTRU may be configured to optionally transmit the UCI using one or more of CW1 and CW2 based on the size of the UCI and whether UL-SCH data is also to be transmitted. For example, the WTRU may be configured to use a different threshold (e.g., a separately configured, higher or lower threshold) to determine whether to split the UCI between two CWs when UL-SCH data is to be transmitted.

There may be UL-SCH indication for two CW transmission. In examples, the WTRU may be configured to determine a priority for one or more CWs. In examples, the WTRU may receive a UL grant scheduling a PUSCH transmission with 2 CWs and/or an UL-SCH indicator. The UL-SCH indicator may comprise one or more values and/or a parameter (e.g., a priority indicator in the UL grant DCI). In examples, the WTRU may determine a priority for one or more CW(s) based on the size of the indication (e.g., the size of the indicator field). In examples, the WTRU may be configured to set the priority for one or more CW(s) based on the indication field having more than one information element. In examples, the WTRU may be configured to set the priority for one or more CWs based on the indicated field having a single information element. In examples, the WTRU may determine a CW to be used for transmission (e.g., transmission of UL-SCH data) based on one or more of the following: an association with the highest MCS, an association with toggled NDI, an association with a specific TRP (e.g., a primary/secondary TRP), and/or a determination by a semi-static or a dynamic indication (e.g., an indication that is RRC configured, a MAC-CE, or another DCI). In examples, the WTRU may transmit a PUSCH according to the determined priority, unless the transmission would result in a collision with a PUCCH.

The following description is for exemplary purposes and does not intend to limit in any way the applicability of the methods described herein to any wireless technology and/or to other technology, when applicable. The term network in this disclosure may refer to one or more gNBs which in turn may be associated with one or more TRPs, or to any other node in the radio access network.

A WTRU may receive a UL-SCH indicator for a two CW operation. The WTRU may be configured to transmit UL-SCH data and/or UCI using one or more CW(s) (e.g., a first CW, CW1, and a second CW, CW2) based on a received UL-SCH indicator. In examples, the WTRU may receive an UL grant scheduling a PUSCH transmission using one or more (e.g., two) CWs. The UL grant may comprise an indicator. The indicator may be, for example, an UL-SCH indicator, which may be a field (e.g., a 1-bit field) in the UL grant DCI. In examples, the WTRU may transmit UL-SCH data and/or UCI using one or more of a first (e.g., CW1) and a second (e.g., CW2). The WTRU may determine to use one or more of CW1 and CW2 to transmit UL-SCH data and/or UCI based on the indicator and/or one or more of the following: a property or parameter of at least one of the CWs, and/or a criticality, importance, and/or priority of the UCI. The property or parameter of at least one of the CWs may, for example, be based on a configuration and/or indication in the DCI. In examples, the property and/or parameter may comprise one or more of: a MCS, an antenna group, a NDI, a HARQ process ID, a TRP, and a SRS. The NDI may be toggled or not toggled. The TRP may be primary or secondary. The SRS may be based on whether the CW is with a first or second SRI. The criticality, importance, and/or priority of the UCI may be based on, for example, HARQ feedback and/or time critical channel state information (CSI) indicated to be transmitted on a CW (e.g., a first CW, CW1, or a second CW, CW2). In examples, the criticality, importance, and/or priority may be based on a respective property or parameter of a CW. For example, if the UCI includes a CSI associated with a high (e.g., first) priority and a CSI associated with a low priority (e.g., a second priority, lower than the first priority), the WTRU may be configured to map the high or first priority CSI to the CW with the higher MCS and to map the low or second priority CSI to the CW with the lower MCS.

The UL-SCH indicator may comprise a bit field. The bit field of the UL-SCH indicator may comprise a value. A WTRU may determine the value of the UL-SCH indicator bit field. The WTRU may determine for data to be sent using one or more CWs based on the determined value of the UL-SCH indicator bit field. In examples, a UL-SCH bit field value (e.g., a value of 1) may indicate that a UL-SCH is to be transmitted on the PUSCH. In examples, a UL-SCH bit field value (e.g., a value of 0) may indicate that a UL-SCH is not to be transmitted on the PUSCH (e.g., UCI only). A WTRU may be scheduled with a PUSCH transmission with 2 CWs, and may receive a UL-SCH indicator comprising a single bit field. If the UL-SCH indicator comprises a single UL-SCH bit field, the WTRU may implement one or more of the following behaviors.

A WTRU may behave based on a selection of one of the CWs. If a WTRU receives a UL-SCH indicator comprising a single bit field, the WTRU may behave based on a selection of one of the CWs. The WTRU may determine a value of the UL-SCH indicator (e.g., the value of the bit field of the UL-SCH), and determine one or more CWs to use for transmission based on the determined value. The received UL-SCH bit field may indicator for an operation to be applied using one or more of the CWs. In examples, the state of the UL-SCH indicator may apply to one CW (e.g., CW1 or CW2), and the other CW may remain dedicated to UL-SCH. For example, if the UL-SCH indicator value=“1”, then CW1 may be used for UL-SCH data, and CW2 may be used for UL-SCH data. For example, if the UL-SCH indicator value=“0”, the CW1 may be used for UL-SCH data, and CW2 may be used for UCI.

The WTRU may determine the CW to remain dedicated and the CW that is the target of the UL-SCH indicator bit field (e.g., indicated to be used for UL-SCH data or UCI) based on one or more of the following: a CW with a higher MCS; a CW associated with an antenna group; a CW associated with a toggled NDI; a CW associated with a specific HARQ process ID; a CW associated with a specific TRP (e.g., a primary/secondary TRP); and/or a CW associated with a first or second SRI.

If a WTRU receives a UL-SCH indicator comprising a single bit field, the WTRU may behave based on a selection of one CW versus two CWs. For example, if the UL-SCH indicator value=“0” (e.g., which may be interpreted as indicating for UCI only transmission), the WTRU may determine whether to use one CW or two CWs for transmission of the UCI based on the UCI size and/or type (e.g., a UCI size threshold). For example, if the UL-SCH indicator value=“1”, the WTRU may determine that CW1 may be used for UL-SCH data, and CW2 may be used for UL-SCH data. If the UL-SCH indicator value=“0”, the WTRU may determine whether to transmit the UCI using one or two CWs based on a UCI size threshold. For example, if the UL-SCH indicator value=“0”, and the UCI size is greater than a UCI size threshold, the WTRU may determine to transmit the UCI using two CWs. The WTRU may split the UCI onto both CWs for transmission. For example, the WTRU may split and map CW1=UCI and CW2=UCI. For example, if the UL-SCH indicator value=“0”, and the UCI size does not meet a UCI size threshold, the WTRU may map the UCI onto a single CW. In examples, the WTRU may map CW1=UCI and CW2=UL-SCH.

If a WTRU receives a UL-SCH indicator comprising a single bit field, the WTRU may behave based on applying the state of the UL-SCH indicator on both CWs. The WTRU may receive the UL-SCH indicator comprising a bit field, and determine the value the received UL-SCH indicator. The WTRU may determine the to apply the determined value of the UL-SCH indicator to both CWs. In examples, WTRU may determine whether to send UL-SCH data or UCI using both the first CW and the second CW based on the determined value of the UL-SCH indicator. For example, both CWs may transmit UL-SCH data or UCI. For example, if the UL-SCH indicator value=“1”, the WTRU may determine to transmit UL-SCH data using CW1 and CW2. For example, if the UL-SCH indicator value=“0”, the WTRU may determine to transmit UCI using both CW1 and CW2.

If the WTRU applies the state of the UL-SCH indicator on both CWs, the WTRU may determine a mapping for the CWs (e.g., map data to CW1 and CW2). For instance, the WTRU may map time critical CSI to one or more of the following: a CW associated with a higher MCS; a CW associated with an antenna group; a CW associated with a toggled NDI; a CW associated with a specific HARQ process ID; a CW associated with a specific TRP (e.g., a primary/secondary TRP); and/or a CW associated with a first or second SRI. In examples, time critical CSI may be type II part I, aperiodic CSI measurement, doppler-related CSI, etc.

A WTRU may receive an indication (e.g., a UL-SCH indicator) in a UL grant (e.g., from a gNB) as to whether the WTRU may send a UCI on the granted PUSCH resource without UL data (e.g., UL-SCH). In examples, for “UCI only on PUSCH”, the WTRU may send UCI on the granted PUSCH resource without UL-SCH. In examples, for “UCI piggybacked PUSCH”, the WTRU may send UCI on the granted PUSCH resource with UL-SCH based on an indication in the UL grant. The indication in the UL grant may be a UL-SCH indicator, and may comprise a bit field. The WTRU may determine a value of the UL-SCH indicator. The uplink may be a dynamic grant, a semi-persistent grant, or a configured grant. A dynamic grant may provide an indication that each DCI schedules a PUSCH resource. A semi-persistent grant may provide an indication that each DCI schedules a set of PUSCH resources for a given time window. A configured grant may provide an indication that PUSCH resources may be semi-statically configured, or activated and deactivated. UCI only on PUSCH may be a PUSCH transmission in which coded bits of a UCI may be transmitted in the granted PUSCH resources. UCI piggybacked PUSCH, which may be a PUSCH transmission in which UCI and UL-SCH may be transmitted together within the granted PUSCH resources.

In examples, if a single UL-SCH bit field is indicated and two CWs may be used for PUSCH and the UL-SCH bit indicates UCI only on PUSCH, the WTRU may perform UCI only on PUSCH for one of the CWs or both. It is noted that, UCI only on PUSCH may be interchangeably used with “UCI only” and “UCI only PUSCH”. Further, it is noted that “CW” may be interchangeably used with “CW”.

A WTRU may be configured to apply the determined UL-SCH indicator value (e.g., bit field) to one of the CWs. The WTRU may be configured to transmit UL-SCH data and/or UCI using one of CW1 or CW2 based on the UL-SCH indicator value determined by the WTRU. In examples, if a UCI is reported in a PUSCH with two CWs, the WTRU may be configured to report or piggyback the UCI in one of the CWs.

The WTRU may determine transmit UL-SCH data or UCI using one or more CW(s) based on the UL-SCH indicator having a parameter. In examples, the WTRU may determine one of the CWs for UCI reporting based on the parameter of the UL-SCH indicator comprising one or more of: an associated MCS for each CW; a CW identity; a CW with new data transmission; an associated HARQ process identity; an associated antenna group; an associated SRI index; an associated TRP index; an associated timing advance (TA) value; and/or a UCI bit overhead. In examples, if the UL-SCH indicator bit field indicates for UCI only on PUSCH, the WTRU may determine a CW for UCI only on PUSCH transmission based on one or more of following: an associated MCS for each CW; a CW identity; a CW with new data transmission; an associated HARQ process identity; an associated antenna group; an associated SRI index; an associated TRP index; an associated TA value; and/or a UCI bit overhead.

The WTRU may determine a CW to use for transmission based on an associated MCS for each CW. The WTRU may determine to use a CW with a higher MCS level. The MCS level may be indicated or determined. In examples, if two CWs have the same MCS level, the WTRU may use a CW with a lowest (or a highest) CW identity for UCI transmission.

The WTRU may determine a CW to use for transmission based on a CW identity. The WTRU may determine a CW with a lowest (or a highest) CW identity for UCI transmission.

The WTRU may determine a CW to use for transmission based on a CW with a new data transmission (e.g., a CW with NDI toggled). For example, if there is two CWs for PUSCH, and a first CW is indicated for retransmission (e.g., NDI not toggled) and a second CW is indicated for new transmission (e.g., NDI toggled), the WTRU may determine to transmit UCI using the second CW.

The WTRU may determine a CW to use for transmission based on an associated HARQ process identity. The WTRU may determine a CW for UCI transmission based on associated HARQ process identity. In examples, the WTRU may determine a CW to use for transmission if an associated HARQ process identity of the CW meets one or more of following: one or more HARQ process identities configured for UCI transmission; an even (or odd) numbered HARQ process identity; and/or a HARQ process identity modulo X becomes Y. In some cases, X and/or Y may be a predetermined number (e.g., X=3, Y=0). In some other cases, X and/or Y may be configured number via a higher layer signaling.

The WTRU may determine a CW to use for transmission based on an associated antenna group. For example, each CW may be associated with an antenna group, and the WTRU may determine a CW based on the associated antenna group identity.

The WTRU may determine a CW to use for transmission based on an associated SRI index. The WTRU may receive one or more SRIs for PUSCH transmission. One or more CW(s) (e.g., each CW) may be associated with an SRI. The WTRU may determine a CW for UCI transmission if a specific SRI is indicated for the respective CW.

The WTRU may determine a CW to use for transmission based on an associated TRP index. For example, if the WTRU is indicated for PUSCH transmission with multiple CWs, each CW may be associated with a TRP (e.g., CSI-RS or SSB). The WTRU may determine a CW associated with a specific TRP or TRP identity (e.g., primary TRP, serving cell TRP, and the like).

The WTRU may determine a CW to use for transmission based on an associated TA value. One or more CW(s) (e.g., each CW) may be associated with a specific TA value. In examples, the WTRU may determine a CW with the smallest TA value for UCI transmission. It is noted that a CW associated with a smallest TA value may be considered as a CW targeted for a TRP closest to the WTRU.

The WTRU may determine a CW to use for transmission based on a UCI bit overhead and/or UCI size. The WTRU may determine a CW with a higher MCS if UCI overhead (or UCI size) is higher than a threshold (e.g., a UCI size threshold). In examples, the WTRU may determine a CW with a lower MCS if UCI overhead (or UCI size) is lower than a threshold (e.g., a UCI size threshold).

In examples, the WTRU may apply different set(s) of conditions for determining one or more CW(s) for UCI transmission based on the UL-SCH indicator and/or parameter. For example, if the WTRU determines a UL-SCH indicator value=“0”, the WTRU may use a first set of conditions to determine a CW for UCI transmission. In examples, if the WTRU determines a UL-SCH indicator value=“1”, the WTRU may be configured to use a second set of conditions to determine a CW for UCI transmission. For example, a first set of conditions may include a CW with a higher MCS, and a second set of conditions may include a CW with HARQ process identity.

In examples, the WTRU may determine the number of CWs to use for transmission (e.g., UCI transmission) based on the size of the UCI. The UCI may be transmitted in the granted PUSCH. For example, if the UCI size is larger than a threshold (e.g., a UCI size threshold), the WTRU may determine to transmit the UCI using a first number of CWs (e.g., 2 CW). For example, if the UCI size is smaller than or equal to the threshold (e.g., a UCI size threshold), the WTRU may determine to transmit the UCI using a second number of CWs (e.g., 1 CW). In examples, multiple CWs may be used for UCI transmission. The WTRU may transmit a high priority UCI in a first CW, and transmit the remaining portion of the UCI in a second CW. High priority UCI may be, for example, a wideband channel quality indicator (CQI), wideband precoding matrix indicator (PMI), rank indicator (RI), HARQ, layer indicator (LI), CSI-RS resource indicator (CRI), etc. Low priority UCI may be, for example, a subband CQI, subband PMI, etc. For example, the first CW may be a CW with higher MCS, smaller TA value, NDI toggled, and/or lower CW identity.

If multiple CWs are used for UCI transmission, the WTRU may split (e.g., evenly split) and transmit UCI bits over multiple CWs. In examples, when UCI is transmitted over multiple CWs, the WTRU may independently code each portion of UCI in each CW.

The WTRU may determine the number of CWs for UCI transmission based on an indication in DCI (e.g., UL-SCH). For example, if the WTRU is indicated as UCI only on PUSCH transmission, the WTRU may determine a single CW transmission irrespective of the rank. For example, if the WTRU is not indicated as UCI only on PUSCH transmission, the WTRU may determine the number of CWs based on the rank indicated by gNB for PUSCH transmission.

A WTRU may be configured for UCI multiplexing for two CW transmission. In examples, the WTRU may be configured to determine the CW and/or resource usage for UCI multiplexing. In examples, the WTRU may determine to transmit UCI using one or more of CW1 and CW2 based on a parameter. In examples, the WTRU may receive a parameter comprising a configuration of a threshold. For example, the WTRU may receive a configuration of a threshold to determine UCI splitting. In examples, the WTRU may receive a UL grant scheduling a PUSCH transmission with two CWs (e.g., CW1 and CW2). In examples, the WTRU may determine to transmit UCI using one or more of CW1 and CW2 based on the size of the UCI. The WTRU may determine to transmit UCI using one or more of CW1 and CW2 based on a UCI size threshold. For example, if the UCI size is greater than a UCI size threshold, the WTRU may split the UCI into parts (e.g., two parts), and transmit a first part using CW1 and a second part using CW2. In examples, if the UCI size is less than the threshold, the WTRU may transmit the UCI using one of CW1 or CW2.

If one CW is used for transmitting the UCI based on the size of the UCI, the WTRU may transmit the UCI using the CW with the higher or lower MCS based on the priority of the UCI. The MCS of the CWs may be indicated by the scheduling grant (e.g., scheduling DCI). In examples, the WTRU may transmit the UCI using the determined one or more CWs. In examples, the WTRU may optionally transmit the UCI using one or more of CW1 and CW2 based on the size of the UCI and whether UL-SCH data is also to be transmitted. For example, the WTRU may be configured to use a different threshold (e.g., a separately configured, higher or lower threshold) to determine whether to split the UCI between the 2CWs when UL-SCH data is to be transmitted.

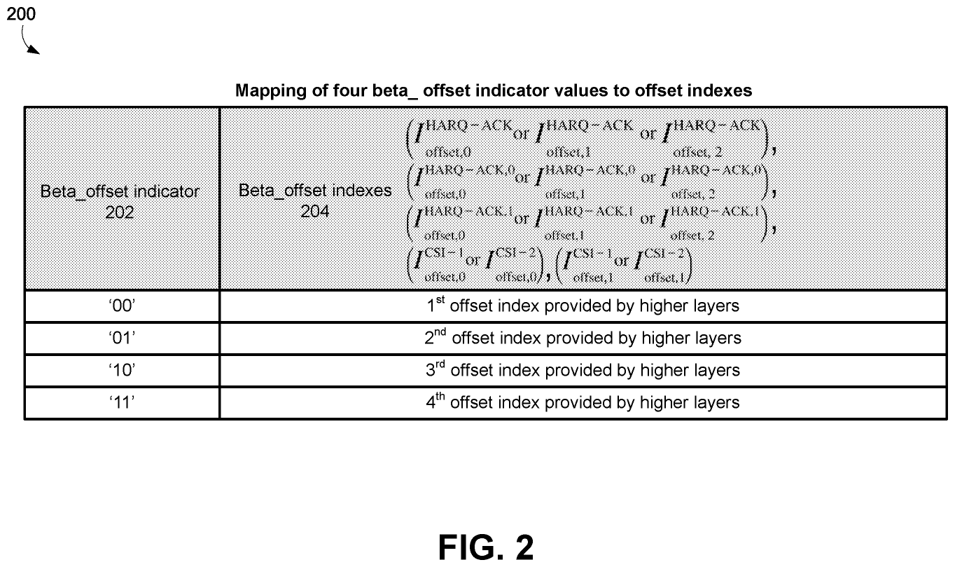

The WTRU may be configured to multiplex UCI information, such as HARQ, ACK/NACK, and/or CSI, on PUSCH. For example, if higher layer parameter betaOffsets=dynamic, a 2 bit length beta_offset indicator in the scheduling DCI may be used to indicate the amount of the PUSCH resources that can be used for UCI multiplexing on PUSCH, as illustrated in FIG. 2.

FIG. 2 is a table of an example mapping 200 of four beta_offset indicator values to offset indexes. The WTRU may determine a CW to use for transmission and/or resource usage for multiplexing.

The WTRU may determine whether to use one or more (e.g., two) CWs for UCI multiplexing. For instance, the WTRU may use two CWs for UCI multiplexing if an RRC configuration (e.g., uci-OnPUSCH-ListDCI-r18) includes two sets of betaOffset indicators 202, and/or if an RRC configuration (e.g., uci-OnPUSCH) includes an index like betaOffsets=dynamic2. In examples, the WTRU may use a single CW for UCI multiplexing.

If a single CW is utilized, the WTRU may determine which CW to use for UCI multiplexing. The WTRU may determine the CW to utilize for UCI multiplexing based on one or more of the following: the CW associated with an antenna group; the CW associated with a toggled NDI; the CW associated with a specific TRP (e.g., primary/secondary TRP); and/or the CW associated with a first/second SRI.

If two CWs are utilized for UCI multiplexing, the WTRU may determine a CSI mapping. The WTRU may map the CSI to a CW based on HARQ, ACK/NACK, and/or CSI part I. In examples, the WTRU may map the CSI onto a CW with a higher MCS, and/or onto the CW associated with an antenna group.

In examples, the WTRU may determine betaOffset for UCI multiplexing. For example, if a single CW is used, the WTRU may determine resource usage for UCI multiplexing according to the indicated betaOffset. In another example, the WTRU may determine betaOffset if two CWs are targeted for UCI multiplexing. For instance, when an RRC configuration includes two betaOffset table similar to the table 200. As illustrated in FIG. 2, the beta_offset indicator 202 in DCI may points to a pair of betaOffset values 204 from individual configured tables. In examples, if the RRC configuration includes a single betaOffset table, but an RRC configuration (e.g., uci-OnPUSCH) includes an index similar to betaOffsets=dynamic2, the WTRU may be configured to apply a same beta_offset value on both CWs.

A WTRU may be configured to transmit one or more CWs in uplink using one or more layers. In examples, the WTRU may transmit two CWs using two layers. In examples, the WTRU may transmit one CW on the first four layers and a second CW on the remaining layers. In some examples, a CW may be interchangeably used with UCI. Further, in some examples, CSI and UCI may be interchangeably used with HARQ-ACK/NACK, CSI part 1 and CSI part 2. Further, in some examples, resources may interchangeably be used with time/frequency domain resources. There may be one or more implementations for resource indication requirements for multiplexing UCI, for example, HARQ-ACK/NACK, CSI part 1, and/or CSI part 2 on one or more CW.

The WTRU may be configured for UCI multiplexing with a DCI indication field present for one or more CWs. For example, an uplink transmission may be scheduled via a DCI format. The uplink transmission may be, for example, but not limited to, a PUSCH transmission with one or more CWs. The DCI format may have an indication field of the resources required for multiplexing UCI on one or more CWs.

The WTRU may be configured for UCI multiplexing on one CW. In examples, the DCI scheduling the PUSCH may contain an indication field for the resources required for multiplexing UCI on one CW. The indication field may contain additional information to indicate the index of a CW for multiplexing UCI. For the cases that include two CWs, the DCI indication field may contain an additional 1 bit information for indicating a CW index for UCI multiplexing.

The DCI may contain a separate indication field for indicating a CW index for UCI multiplexing. For the cases that include two CWs, a DCI format scheduling the PUSCH may contain a separate indication field for indicating a CW index for UCI multiplexing.

The DCI scheduling the PUSCH may not contain a separate indication field for indicating the index of a CW for UCI multiplexing. The DCI indication field for the resources required also may not have additional information for indicating index of a CW for UCI multiplexing. In examples, the WTRU may multiplex UCI on the CW transmitted on the first N layers. In examples, the WTRU may determine the index of a CW for multiplexing UCI based on a specific MCS. For example, the WTRU may multiplex UCI on a CW with the highest MCS. In some cases, the WTRU may determine a CW index associated with a toggled NDI as the target CW for multiplexing UCI. If more than one CW is toggled with an NDI, the WTRU may determine the first CW toggled with an NDI as the CW for multiplexing UCI.

The WTRU may be configured for UCI multiplexing on more than one CW. In examples, the DCI indication field for indicating the resources required for multiplexing UCI may be applicable to some CWs (e.g., all). In one or more other cases, the DCI may contain a separate indication for each CW for multiplexing UCI. For instance, each DCI indication field for each CW may include additional information on the type of UCI to multiplex on the CW. In examples, a two-bit additional information in the indication field may be included to indicate the type of UCI (e.g., HARQ-ACK/NACK, CSI part 1, and/or CSI part 2) to be multiplexed on the CW. In examples, a two-bit additional indication in the indication field may be included to indicate the type of UCI (e.g., HARQ-ACK/NACK, or CSI part 1 and CSI part 2, or HARQ-ACK/NACK, CSI part 1 and CSI part 2).

The WTRU may receive an indication of a threshold (e.g., threshold_UCI) from the network (e.g., via RRC signaling). The WTRU may be configured with and/or indicated a threshold. The WTRU may receive or determine a parameter comprising a UCI size threshold. For example, the WTRU may receive the parameter in a field of the UL grant DCI, and/or determine the parameter based on the CW. In examples, the parameter may comprise a threshold (e.g., a UCI size threshold), and the WTRU may use the parameter to determine whether one or more CWs will be utilized for multiplexing UCI. To determine whether one or more CWs are to be used for UCI multiplexing, the WTRU may do one or more of the following:

To determine whether to use one or more CWs for UCI multiplexing, if UCI size meets the configured and/or indicated threshold (e.g., threshold_UCI), the WTRU may determine whether one or more CWs should be used for UCI multiplexing. For instance, the WTRU may use more than one CW when if UCI payload size exceeds a configured threshold. In examples, the WTRU may use only one CW for UCI multiplexing when the UCI size falls below a threshold (e.g., a UCI size threshold).

If the WTRU uses more than one CW, the WTRU may split the UCI payload into parts (e.g., two parts) and map each part according to its priority and/or time sensitivity to different CWs. For example, the WTRU may use the CW associated with a higher transmission quality metric (e.g., a higher MCS, higher power capability, coherency, etc.) for the UCI payload with a higher priority (e.g., ACK/NACK, SP-CSI, Doppler domain information, time correlation information, etc.).

If the WTRU uses more than one CW, the WTRU may scale the indicated resource usage (e.g., the betaoffset) for each CW differently. The WTRU may scale the resource usage for each CW according to the CW's corresponding MCS value, for example, to prevent penalizing the CW associated with the lower MCS. Penalizing a CW may mean allocating less resources to the CW, which may lead to a worse performance. In examples, the WTRU may scale the indicated betaoffset value for each CW with a first and second scaling factor, for the CW with the highest and lowest MCS, respectively. In examples, the first scaling factor may be a function of unity, and the second scaling factor may be a function of the MCS. In examples, at least one of the scaling factors may be configurable.

The WTRU may be configured for UCI multiplexing without a DCI indication field for the required resources. In examples, a WTRU may be configured to schedule an uplink transmission (e.g., PUSCH transmission) with one or more CWs via a DCI format. The DCI format may or may not have certain fields/indication fields. For example, the DCI format may not include an indicator field for indication of the resources required for multiplexing UCI using one or more CWs. In another example, the DCI format may not include an indicator (e.g., an indicator field) of a CW used for multiplexing UCI. For instance, the DCI format may not include an indication field to multiplexing UCI on the first CW or to multiplex UCI on the second CW.

The WTRU may be configured for UCI multiplexing using one CW. In examples, the WTRU may receive an RRC configuration (e.g., configuration_DCI-format_UCI-resource). The configuration may include an indication of the CW index for multiplexing UCI. In examples, the configuration may include an indication to multiplex UCI on one of the CWs. The configuration may include an indication to multiplex UCI on the first CW or multiplex UCI on the second CW. The configuration may include a separate indication of the resources required for multiplexing HARQ-ACK, CSI part 1, and/or CSI part 2. In examples, the configuration may include one or more of: an index of the CW for multiplexing UCI, an indication of the resources required for HARQ-ACK, and/or an indication of resources required for CSI part 1. In examples, the WTRU may determine the resources required for CSI part 2 as function of the indicated resources for CSI part 1. In one or more cases, the WTRU may receive a configuration comprising one or more of an index of the CW for multiplexing UCI, an indication of the resources required for HARQ-ACK, and/or an indication of resources required for CSI part 2. The WTRU may determine the resources required for CSI part 1 as a function of the indicated resources for CSI part 2.

The WTRU may determine the index of a CW for multiplexing UCI based on the layer index. In examples, the WTRU may multiplex UCI on the CW transmitted on the first N layers. In another example, the WTRU may multiplex UCI on the CW transmitted on a layer other than the first N layers. In examples, the WTRU may determine the index of a CW for multiplexing UCI based on a CW with specific MCS. In examples, the WTRU may multiplex UCI on a CW with the highest MCS. In examples, the WTRU may multiplex UCI on a CW with the lowest MCS. In examples, the WTRU may determine a CW index associated with a toggled NDI as the target CW (e.g., the CW to be used for multiplexing UCI). If more than one CW is toggled with an NDI, the WTRU may determine the one of the CWs toggled with an NDI as the CW for multiplexing UCI (e.g., the first CW toggled with an NDI, or the second CW toggled with an NDI).

The WTRU may configure uplink transmissions (e.g., PUSCH transmissions) with different priorities. For example, a PUSCH transmission may have a priority (e.g., 0 or 1). A PUSCH transmission with a specific priority value (e.g., a priority of 1) may be considered a higher priority PUSCH transmission. In examples, a PUSCH transmission with priority value of 0 may be considered a low priority PUSCH transmission relative to a PUSCH transmission with priority value of 1. In examples, a PUSCH transmission may have a priority 1 or 0, in which a PUSCH with priority 0 may be considered a higher priority PUSCH transmission and a PUSCH with priority 1 may be considered as a low priority PUSCH transmission relative to PUSCH transmission with priority 0. Each CW may also have a priority. In examples using two CWs, each CW may have a priority value (e.g., a value of 1 or 0). A CW with priority 1 may be considered as a high priority transmission as compared to a CW with priority 0. Alternatively, a CW with priority 0 may be considered as a high priority transmission as compared to a CW with priority 1. The WTRU may be configured to determine and assign a priority to a CW, and provide a priority indication.

If uplink transmissions have different priorities, and/or each CW on a PUSCH transmission has different priorities, one or more of the following may apply. The WTRU may receive an RRC configuration. The RRC configuration may be configured based on a DCI format scheduling the PUSCH and the priority value of the PUSCH. In examples, the WTRU may receive configuration_PUSCH-1_DCI-format, for a PUSCH with priority 1 for multiplexing UCI (e.g., HARQ-ACK/NACK and/or CSI part 1 and/or CSI part 2). The RRC configuration may comprise an indication of the CW for multiplexing UCI. In examples, the WTRU may receive a dynamically indicated MAC-CE indication or a DCI indication of the CW index for multiplexing UCI. In examples, the RRC configuration may be configured based on the required number of bits for HARQ-ACK/NACK, CSI part 1, and/or CSI part 2. In examples, the WTRU may be configured with one or more of the following RRC configurations: configuration_PUSCH-1_DCI-format_Confi-1, configuration_PUSCH-1_DCI-format_Confi-2, and configuration_PUSCH-1_DCI-format_Confi-3. The WTRU may be configured with configuration_PUSCH-1_DCI-format_Confi-1 if the required number of resources for HARQ-ACK/NACK, CSI part 1, and/or CSI part 2 is less than a threshold (e.g., threshold_a). The WTRU may be receive a configuration comprising configuration_PUSCH-1_DCI-format_Confi-2 if the required number of resources for HARQ-ACK/NACK, CSI part 1, and/or CSI part 2 is greater than a threshold_a and less than threshold_b. The WTRU may receive a configuration comprising configuration_PUSCH-1_DCI-format_Confi-3 if the required number of resources for HARQ-ACK/NACK, CSI part 1, and/or CSI part 2 is equal to greater than threshold_b.

The WTRU may be configured for UCI multiplexing on more than one CW. The DCI format scheduling the PUSCH may or may not comprise an indication field of the required resources for any of the CWs for multiplexing UCI. One or more of the following may apply.

The WTRU may receive an RRC configuration (e.g., configuration_DCI-format_UCI-resource_CW-index). For each CW, the WTRU may receive a configuration comprising the type of UCI to multiplex on a CW (e.g., HARQ-ACK/NACK, CSI part 1, CSI part 2, and/or an indication of the required resources for multiplexing UCI on a CW.

In examples, the WTRU may determine the index of a CW for multiplexing a specific type of UCI, (e.g., HARQ-ACK/NACK, CSI part 1, and/or CSI part 2) based on the layer index. In examples, the WTRU may multiplex HARQ-ACK/NACK, CSI part 1, and/or CSI part 2 on the CW transmitted on the first N layers. In examples, the WTRU may multiplex the remaining UCI, if any, on the CW transmitted on a layer other than the first N layers.

The WTRU may determine the index of a CW for multiplexing a specific type of UCI (e.g., HARQ-ACK/NACK, CSI part 1, and/or CSI part 2) based on a CW with specific MCS. In examples, the WTRU may multiplex HARQ-ACK/NACK, CSI part 1, and/or CSI part 2 on the CW with the highest MCS.

In examples, the WTRU may determine a CW index associated with a toggled NDI as the target CW for multiplexing a specific UCI. If more than one CW is toggled with an NDI, the WTRU may determine the first CW toggled with an NDI to be the CW for multiplexing a specific UCI (e.g., HARQ-ACK/NACK, CSI part 1, and/or CSI part 2). Alternatively, the WTRU may determine the second CW toggled with an NDI, to be the CW for multiplexing a specific UCI.

For PUSCH transmissions with different priorities (e.g., priority 0 or priority 1), and if each CW comprises a priority value (e.g., CW1 with priority 0 and CW2 with priority 1) one or more of the following may apply for allocating resources for UCI multiplexing on PUSCH. In examples, the WTRU may receive an RRC configuration. The configuration (e.g., RRC configuration) may be based on one or more of a DCI format scheduling the PUSCH, the priority value of the PUSCH, and/or the priority value of a CW. For example, the WTRU may receive configuration_PUSCH-1_DCI-format_CW-0, for a CW with priority 0 of a PUSCH transmission with priority 1 for multiplexing UCI. The RRC configuration may comprise the type of UCI (e.g., HARQ-ACK/NACK, CSI part 1, and/or CSI part 2) to multiplex on the CW. The RRC configuration may comprise an indication of the resources to be used for multiplexing the specific type of UCI on a particular CW of a PUSCH. In one or more other cases, the WTRU may receive a dynamically indicated MAC-CE indication or DCI indication of the UCI type, resources required for multiplexing the UCI, and the CW index for multiplexing the UCI.

The RRC configuration may be based on the required number of bits for HARQ-ACK/NACK, CSI part 1, and/or CSI part 2. In examples, the WTRU may receive one or more of the following RRC configurations: configuration_PUSCH-1_DCI-format_Confi-1_CW-1, configuration_PUSCH-1_DCI-format_Confi-2_CW-0, and/or configuration_PUSCH-0_DCI-format_Confi-3_CW-1. The WTRU may be configured with configuration_PUSCH-1_DCI-format_Confi-1_CW-1 if the required number of resources for HARQ-ACK/NACK, CSI part 1, and/or CSI part 2 on, for example, PUSCH with priority 1. The PUSCH may be scheduled by DCI format, for example, DCI format 0_0/0_1. The configuration may indicate for UCI to be multiplexed on a CW with priority 1 that is less than a threshold (e.g., threshold_a).

The WTRU may receive a configuration comprising configuration_PUSCH-1_DCI-format_Confi-2_CW-0 if the required number of resources for HARQ-ACK/NACK, CSI part 1, and/or CSI part 2 on, for example, PUSCH with priority 1. The PUSCH transmission may be scheduled by DCI format, for example, DCI format 0_0/0_1. The configuration may indicate for UCI to be multiplexed on a CW with priority 0 that is greater than threshold_a and less than threshold_b.

The WTRU may receive a configuration comprising configuration_PUSCH-0_DCI-format_Confi-3_CW-1 if the required number of resources for HARQ-ACK/NACK, CSI part 1, and/or CSI part 2 on, for example, PUSCH with priority 0. The PUSCH transmission may be scheduled by DCI format, for example, DCI format 0_0/0_1. The configuration may indicate for UCI to be multiplexed on a CW with priority 1 that is greater than threshold_b.

In examples, the WTRU may be configured for priority indication for two CW transmission. The WTRU may be configured to set a different priority for each CW (e.g., CW1 and CW2). In examples, the WTRU may be configured to receive a UL grant scheduling a PUSCH transmission with 2 CWs. The UL grant may comprise an indication comprising, for example, a priority indicator in the UL grant DCI. In examples, the WTRU may determine whether a priority should be set per CW based on the size of the indicator field.

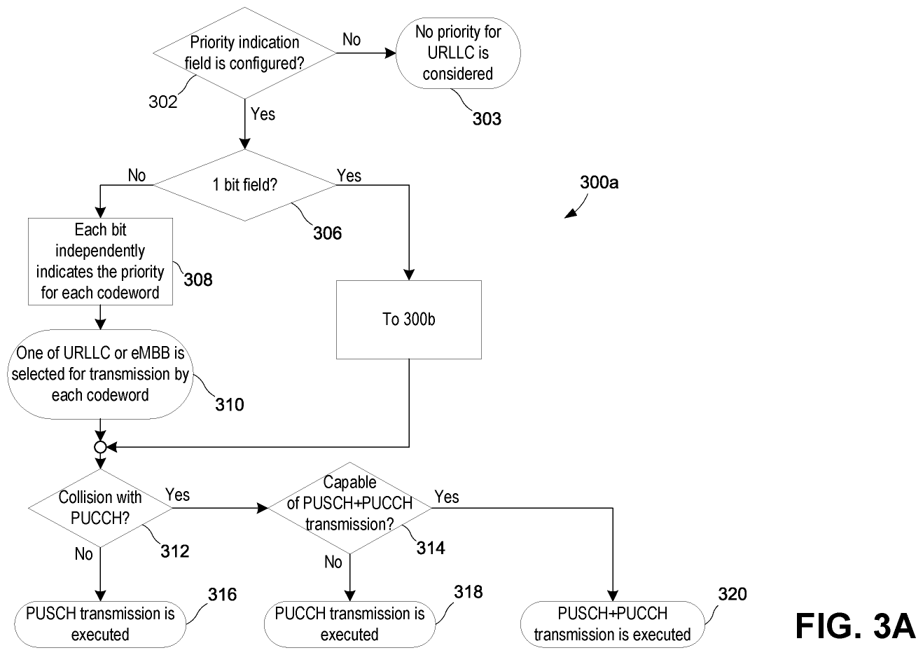

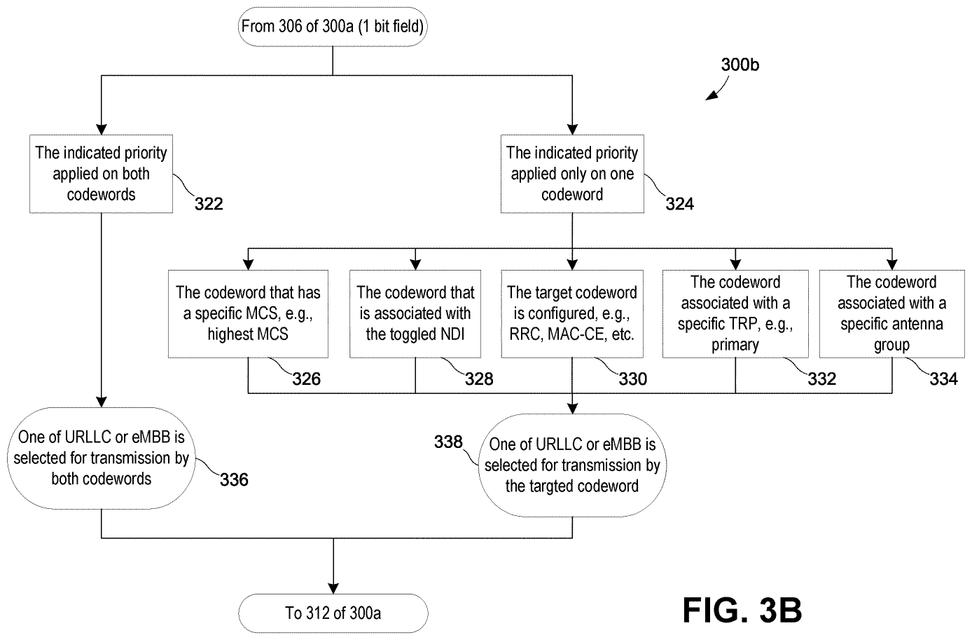

FIG. 3A is an example procedure 300a, 300b for priority indication based on configured DCI field length. At 302, the WTRU may determine if there is a configured priority field (e.g., a priority indicator in the UL grant DCI). If the WTRU determines that there is not a priority field, the WTRU may determine that there is no priority for URLLC at 303. If the WTRU determines that there is a priority field at 302, the WTRU may determine if the priority indicator field comprises more than one information element (e.g., a 1-bit or 2-bit field) at 306. At 308, the WTRU may be configured to set the priority independently per CW based on the indicator field having more than one information element.

If, at 306, the WTRU determines the priority indicator field comprises only 1 information element (e.g., 1 bit), the WTRU may be configured to set the priority for one or more CWs, for example, as shown in FIG. 3B. FIG. 3B illustrates an example sub-procedure 300b of procedure 300a for 1-bit field priority indications. In examples, the WTRU may be configured to set the priority for one CW at 324, or both CWs at 322, based on the indicated field having a single information element. The WTRU may be configured to select a CW based on one or more of the following: an association with the highest MCS at 326, an association with toggled NDI at 328, an association with a specific TRP (e.g., a primary/secondary TRP) at 332, and/or a determination by a semi-static or a dynamic indication (e.g., an indication that is RRC configured, a MAC-CE, or another DCI) at 330. At 312, the WTRU may determine if a PUSCH transmission would result in a collision. If the PUSCH transmission would not result in a collision with a PUCCH, the WTRU may be configured to transmit a PUSCH according to the determined priority at 316.

The priority indication (e.g., a 0 or 1 bit) may provide ultra-reliability low latency communication (URLLC) support, and may be used to indicate the priority of an uplink transmission. If in an active DL bandwidth part (BWP), the WTRU may monitor PDCCH for detection of a DCI format comprising a priority indicator field. If configured, the priority indicator field may comprise a priority index. For example, DCI format 0_1 may be configured to carry the priority indication bit field to indicate the priority of the scheduled uplink transmission. In examples, for an 8TX WTRU scheduled for an uplink transmission with two CWs, if the priority field in an uplink scheduling DCI is configured, the WTRU may apply one or more of the following steps.

If, at 306, the WTRU determines the priority field is configured with a 2-bit length DCI field, each bit may set the priority of each CW independently at 308. In examples, if the priority for one of the CW is reduced, in case of a collision with PUCCH, the priority of the other CW is assumed to be reduced as well. At 310, URLLC or eMBB may be selected for transmission using each CW.

If, at 306, the WTRU determines the priority field is configured with single bit DCI field, the WTRU may determine the value of the field as indicating the priority for both CWs at 322. At 336, one of URLLC or eMBB may be selected for transmission using both CWs.

If the WTRU is configured with a single bit DCI field, the state of the field may determine the priority for only one of the two CWs at 324. The WTRU may determine the CW to be used (e.g., the target CW) based on one or more of: the CW with the highest MCS at 326; the CW with the toggled NDI at 328; the CW being RRC configured, or dynamically indicated by a MAC-CE or another DCI at 330; and/or the CW associated with a specific TRP (e.g., primary/secondary TRP) at 332. In examples, when the priority for one of the CW is reduced, in case of a collision with PUCCH, the priority of the other CW is assumed to be reduced as well. At 338, one of URLLC or eMBB may be selected for transmission by the targeted CW.

In examples, the WTRU may be configured to set a different priority for each CW. For an uplink transmission, the WTRU may support different traffic types, for example, URLLC, enhanced mobile broadband (eMBB), and the like. While transmission of eMBB traffic may utilize time and frequency resources, URLLC transmissions may be sporadic and may utilize fewer resources to complete the transmission. If the WTRU is scheduled for transmission with two CWs and receives a priority index, the WTRU may not need to allocate both CWs for transmission of the URLLC payload.

In examples, the WTRU may be configured semi-statically to include a field for priority indication in a scheduling DCI. For an 8TX WTRU scheduled for an uplink transmission with more than one CWs, if priority indication field in an uplink scheduling DCI is configured, the WTRU may apply one or more of the following. In examples, the WTRU may be configured with more than one-bit length DCI field, in which each bit may indicate the priority for each CW independently. For example, if the WTRU is configured with a 2-bit length field in the DCI, at 308, the WTRU may determine the first and second bit to indicate the priority for the first and second CWs, respectively.

In examples, if the priority of only one of the CW is reduced, in case of a collision with a PUCCH transmission, transmission of both CWs may be cancelled and the WTRU may proceed with the transmission of the PUCCH at 318. At 314, the WTRU may indicate a capability to support simultaneous transmission of PUSCH and PUCCH. If the WTRU indicates it supports simultaneous transmission of PUSCH and PUCCH at 314, the WTRU may proceed with transmitting the PUSCH and PUCCH at 320. In examples, if the priority of one of the CW is reduced, in case of a collision with a PUCCH transmission, the WTRU may proceed with transmission of the other CW and PUCCH at 318. In examples, for a given max configured transmission power, the WTRU may prioritize PUCCH transmissions for power allocation.

In one or more other cases, the WTRU may be configured with a single 1-bit DCI field for priority indication and may utilize the procedure 300b. The WTRU may apply one or more of the following options. For example, at 322, the WTRU may determine the 1-bit priority indication field to indicate the priority for both CWs. In examples, both scheduled CWs may be held, and the WTRU may proceed with transmission of the higher priority scheduled transmission (e.g., URLLC payload). Alternatively, at 324, the WTRU may interpret the state of the priority indication field as the state of the priority for only one of the scheduled CWs, and the transmission of the other scheduled CW may proceed.

In examples, the WTRU may determine the target CW for application of the received priority indicator by employing one or more of the following. At 326, the WTRU may determine to use the CW with a specific MCS. For example, the WTRU may consider the CW with the highest MCS as the target for application of the received priority indicator to insure a better transmission channel for transmission of the URLLC payload. At 328, the WTRU may determine to use the CW associated with the toggled NDI as the target CW. For example, if channel corresponding to that CW has a more robust channel. At 330, the WTRU may determine to use the CW for application of the received priority indicator based on a configuration. For example, the CW may be RRC configured, or dynamically indicated by a MAC-CE or another received DCI. At 332, the WTRU may determine to use the CW for application of the received priority indicator as the CW associated with a specific TRP (e.g., primary/secondary TRP). The association may be implied by, for example, but not limited to a specific configured TCI, an indicated SRI, SSBRI, a CORESETPoolIndex, SRS resource set index, and the like. At 334, the WTRU may determine the target CW based on an associated antenna group, panel, and the like. For example, the WTRU may identify the target CW as the CW mapped to the first antenna group for a scheduled uplink transmission. The indication may be provided in the form of, for example, but not limited to, an indicated SRI, antenna group index, SRS resource set index, and the like.

The WTRU may determine if there will be a collision between the PUSCH transmission and a PUCCH transmission at 312. If no collision is detected, the WTRU may execute the PUSCH transmission at 316. In examples, if the priority of only one of the CW is reduced, in case of a collision with a PUCCH transmission, transmission of both CWs may be cancelled and the WTRU may proceed with transmission of PUCCH at 318.

At 314, the WTRU may indicate its capability to support simultaneous transmission of the PUSCH and PUCCH, and may proceed to execute the PUSCH and PUCCH at 320 if the capability is supported. In examples, if the priority of only one of the CW is reduced, in case of a collision with a PUCCH transmission, the WTRU may proceed with transmission of the other CW and PUCCH. In examples, for a given max configured transmission power, the WTRU may prioritize PUCCH transmission for power allocation.

WTRU behavior for multiplexing rules based on the priority indicator per CW may be described herein. Collisions may occur when a WTRU is scheduled with a PUSCH transmission in a slot, and/or collisions may occur when the WTRU is scheduled to transmit a UCI (e.g., a UCI that carries control information such as CSI or HARQ). The WTRU may transmit the UCI using a PUCCH resource. However, in instances where there is a collision, the WTRU may multiplex the PUCCH into the resources used for the PUSCH. If the WTRU transmits PUSCH with two CWs with priority indicators, the multiplexing rules for the PUCCH may not be clearly defined. The multiplexing rules may be defined for the STxMP cases where the UE simultaneously transmits PUSCH+PUSCH or PUSCH+PUCCH.

In some examples, the WTRU may determine the multiplexing rule of PUCCH onto PUSCH resources as a function of the priority indicator per CW (e.g., if the WTRU receives a priority indicator in a DCI per CW).

The WTRU may be scheduled for a PUSCH+PUSCH transmission in a slot where the first PUSCH carries the first CW and the second PUSCH carries the second CW (e.g., when in a sDCI STxMP transmission mode). The WTRU may be scheduled with a PUCCH transmission that occurs in the same slot. The WTRU may determine to multiplex the PUCCH contents onto the PUSCH CW with the highest or lowest indicated priority. Both PUSCH transmissions may be scheduled by a DG (dynamic grant) or CG (configured grant).

The WTRU may be scheduled for PUSCH+PUSCH transmissions independently by two different DCIs (e.g., when in mDCI STxMP). The PUSCH transmissions may or may not overlap (e.g., the PUSH transmission may partially overlap, completely overlap, or not overlap with each other). Each PUSCH transmission may be scheduled with two CWs and/or priority indications per DCI. The WTRU may be scheduled with a PUCCH that collides with the PUSCHs.

If the priority indicators are not the same, the WTRU may multiplex the PUCCH on the PUSCH CWs with the lowest or highest priority indices. The WTRU may determine the lowest or highest coresetPoolIndex, and determine the CWs per coresetPoolIndex. For example, assuming CW 1 has the highest priority, the WTRU may multiplex on CWs 1 and 2 with coresetPoolIndex=0, and then multiplex on CWs with coresetPoolIndex=1. Alternatively or additionally, the WTRU may determine the CWs with the highest or lowest priority, and then determine the coresetPoolIndex. For example, assuming CW 1 has the highest priority, the WTRU may multiplex on CW 1 from both coresetPoolIndex, and then multiplex on CW 2 from both coresetPoolIndex.

If the priority indicators are the same, the WTRU may multiplex the PUCCH on the PUSCH that starts earliest in time. Alternatively or additionally, the WTRU may multiplex onto the PUSCH with the lowest or highest coresetPoolIndex.

The WTRU may be scheduled for a PUSCH+PUCCH transmission where the PUSCH carries CWs one and two (e.g., with STxMP). The WTRU may receive a priority indicator per CW. The resources allocated for the PUCCH may not be sufficient to carry all the scheduled content bits (e.g., UCI). The WTRU may determine that a subset of the content may be dropped. For example, the PUCCH may carry a UCI for a CSI report and the WTRU may determine to include a subset of the CSI report on the PUCCH. The WTRU may determine to multiplex the dropped contents onto one or more of the PUSCH CW indices where, for example, the WTRU may determine the CW index based on the highest or lowest priority index indicated in the DCI.

In some examples, the WTRU may be scheduled for a PUSCH transmission where the PUSCH carries CWs one and two with indicated priority per CW. In such examples, the WTRU may be scheduled for a PUCCH transmission in the same slot. The WTRU may determine to multiplex the PUCCH onto one or more CWs as a function of the priority indicator per CW received in the DCI. For example, the WTRU may multiplex the PUCCH onto the CW with the highest or lowest priority indicator. If both priority indicators are the same, the WTRU may multiplex the contents onto both CWs. For example, the WTRU may multiplex onto the CW with the lowest or highest index (e.g., CW 1) and then multiplexes onto the other CW (e.g., if needed). Alternatively or additionally, the WTRU may be configured with a splitting factor that the WTRU may use to determine the fraction of contents to multiplex on the first and second CW if they both have the same indicated priority. For example, the splitting factor may be a percentage, such as 50%. In such examples, the WTRU may multiplex 50% of the PUCCH on the first CW, and the other 50% of the PUCCH on the second CW.

What is claimed is:

1. A wireless transmit receive unit, WTRU, comprising:
a processor configured to:
receive an uplink (UL) grant that schedules a physical uplink shared channel (PUSCH) transmission using a first CW (CW) and a second CW, wherein the UL grant comprises an uplink shared channel (UL-SCH) indicator;
determine a value of the UL-SCH indicator;
determine to send UL-SCH data using the first CW and the second CW based on the UL-SCH indicator having a first value;
wherein, in response to a determination that the UL-SCH indicator has a second value, the processor is configured to determine to send UL-SCH data using the first CW, and determine whether to send UL-SCH data or uplink control information (UCI) using the second CW based on the UL-SCH indicator having the second value and a parameter; and
transmit UL-SCH data or UCI using the first and second CWs based on the determinations.

2. The WTRU of claim 1, wherein the parameter is associated with the second CW, and wherein the parameter comprises any of: a configuration indicated in downlink control information (DCI), a modulation and coding scheme (MCS), an antenna group, a New Data Indicator (NDI), a hybrid automatic repeat request (HARQ) process identification, a transmission/reception port (TRP), or a sounding reference signal (SRS) resource indicator (SRI).

3. The WTRU of claim 2, wherein the NDI is either toggled or not toggled, wherein the TRP is either primary or secondary, and wherein the SRS indicates whether the second CW is associated with a first or second SRI.

4. The WTRU of claim 1, wherein the parameter comprises a priority of the UCI.

5. The WTRU of claim 4, wherein the priority is associated with hybrid automatic repeat request (HARQ) feedback or time critical channel state information (CSI), wherein the priority indicates to transmit on the first CW or second CW.

6. The WTRU of claim 1, wherein the parameter comprises a UCI size threshold, and wherein the processor is configured to send UCI using the second CW if the UCI at the WTRU is greater than the UCI size threshold, and configured to send UL-SCH data using the second CW if the UCI at the WTRU is less than the UCI size threshold.

7. The WTRU of claim 1, wherein the UL-SCH indicator comprises a field in UL grant DCI.

8. A method performed by a wireless transmit receive unit, WTRU, comprising:
receiving an uplink (UL) grant that schedules a physical uplink shared channel (PUSCH) transmission using a first CW (CW) and a second CW, wherein the UL grant comprises an uplink shared channel (UL-SCH) indicator;
determining a value of the UL-SCH indicator;
determining whether to send UL-SCH data or uplink control information (UCI) based on the value of the UL-SCH indicator;
wherein, if the UL-SCH indicator has a first value, the method comprises determining to send UL-SCH data using the first CW and the second CW;
wherein, if the UL-SCH indicator has a second value, the method comprises determining to send UL-SCH data using the first CW, and determining to send UL-SCH data or uplink control information (UCI) using the second CW based on a parameter; and
transmitting UL-SCH data or UCI using the first and second CWs based on the determinations.

9. The method of claim 8, wherein the parameter is associated with the second CW, and wherein the parameter comprises any of: a configuration indicated in the DCI, a modulation and coding scheme (MCS), an antenna group, a New Data Indicator (NDI), a hybrid automatic repeat request (HARQ) process identification, a transmission/reception port (TRP), or a sounding reference signal (SRS) resource indicator (SRI).

10. The method of claim 9, wherein the NDI is either toggled or not toggled, wherein the TRP is either primary or secondary, and wherein the SRS indicates whether the second CW is associated with a first or second SRI.

11. The method of claim 8, wherein the parameter comprises a priority of the UCI.

12. The method of claim 11, wherein the priority is associated with HARQ feedback or time critical channel state information (CSI), wherein the priority indicates to transmit on the first CW or second CW.

13. The method of claim 8, wherein the parameter comprises a UCI size threshold, and wherein the processor is configured to send UCI using the second CW if the UCI at the WTRU is greater than the UCI size threshold, and configured to send UL-SCH data using the second CW if the UCI at the WTRU is less than the UCI size threshold.

14. The method of claim 8, wherein the UL-SCH indicator comprises a field in UL grant DCI.

15. A wireless transmit receive unit, WTRU, comprising a processor configured to:
receive an uplink (UL) grant that schedules a physical uplink shared channel (PUSCH) transmission using a first CW (CW) and a second CW, wherein the UL grant comprises an uplink shared channel (UL-SCH) indicator;
determine a value of the UL-SCH indicator;
determine whether to send UL-SCH data or uplink control information (UCI) using the first CW and the second CW based on the value;
wherein, in response to a determination that the UL-SCH indicator has a first value, the processor is configured to determine to send UL-SCH data using the first CW and second CW, and wherein, in response to a determination that the UL-SCH indicator has a second value, the processor is configured to determine to send uplink control information (UCI) using the first CW and second CW; and
transmit UL-SCH data or UCI using the first and second CWs based on the determinations.

16. The WTRU of claim 15, wherein the UL-SCH indicator comprises a field in UL grant downlink control information (DCI).
